(19) United States
(12) Patent Application Publication
(10) Pub. No.: US 2020/0279510 A1
(43) Pub. Date: Sep. 3, 2020

(54) SYSTEMS AND METHODS FOR SIMULATING SURGICAL PROCEDURES

(71) Applicants: Bharat Yarlagadda, Needham, MA (US); Fanny Gabrysz-Forget, Cambridge, MA (US)

(72) Inventors: Bharat Yarlagadda, Needham, MA (US); Fanny Gabrysz-Forget, Cambridge, MA (US)

(21) Appl. No.: 16/289,625

(22) Filed: Feb. 28, 2019

(51) Int. Cl. G09B 23/34

(52) U.S. Cl. CPC G09B 23/34

(57) ABSTRACT

Systems for simulating surgical procedures with an instrument having a first material for manipulation with the instrument and a second material extending through the first material, wherein the second material is electrically conductive.

### CROSS-REFERENCE TO RELATED APPLICATION

None.

### STATEMENT REGARDING FEDERALLY SPONSORED RESEARCH & DEVELOPMENT

None.

### FIELD OF THE INVENTION

The invention relates to systems for simulating surgical procedures and methods of performing the surgical procedures on the systems.

### BACKGROUND OF THE INVENTION

The teaching and practice of surgical procedures on live patients can be risky for many reasons. One such reason is that components of the body may be subject to harmful contact by an instrument in use by a physician, veterinarian, student, nurse, or other health professional when performing the surgical procedure. To reduce harmful contact to bodily components, it would be desirable to have systems that allow health professionals to teach and practice surgical procedures prior to operating on a live patient. In particular, it would be highly desirable to have systems for simulating surgical procedures that are capable of informing users when sensitive bodily components have been contacted or have been contacted in a harmful manner with an instrument.

### SUMMARY OF THE INVENTION

The present invention comprises systems for simulating surgical procedures with an instrument. The systems have a first material for manipulation with the instrument and a second material extending through the first material, wherein the second material is electrically conductive. The present invention also comprises methods for simulating a surgical procedure. The methods include manipulating a first material, and contacting a surgical instrument with a second material, the second material extending within the first material, the surgical instrument and the second material being components of an electrical circuit.

### DESCRIPTION OF THE FIGURES

FIG. 1 shows a front view of a system according to the invention.

FIG. 2 shows a front view of a model of a system according to the invention.

FIG. 3 shows a front view of a component of the model of FIG. 2.

FIG. 4 shows a flow chart of a method for making a model for a system according to the invention.

FIG. 5 shows a view of components used to make a model according to the flow chart of FIG. 4.

FIG. 6 shows a flow chart of a method for using a system according to the invention.

### DETAILED DESCRIPTION

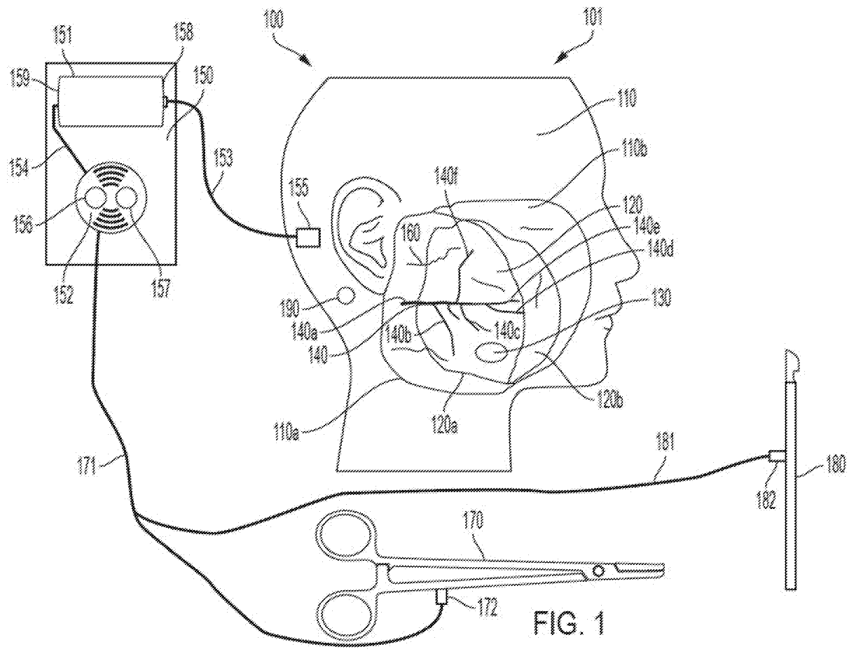

The embodiment shown in FIG. 1 is a system 100 comprising a model 101 in the shape of a portion of the human head and neck. System 100 is used to simulate surgery on a patient, and in this case, to simulate parotid surgery on a patient. System 101 is in use. In other words, model 101 of system 100 has been cut and opened by a user of system 100 who is practicing parotid surgery. In alternative embodiments, the system can be used to practice a wide range of surgeries on human or animal patients.

Model 101 includes a first region 110 that is made of a soft material. In this embodiment, the soft material of first region 110 is silicone based and non-conductive. In alternative embodiments, first region 110 may be made from latex, acrylic, or another material. First region 110 represents the skin and flesh of a patient undergoing parotid surgery. In some embodiments, one or more physical characteristics of first region 110 are set to simulate physical characteristics of the skin and flesh of a patient. For example, the density of the soft material of first region 110 may be set at or near the density of flesh. In this embodiment, the color of the soft material of the first region 110 is tan.

Model 101 of FIG. 1 is in use. In FIG. 1, first region 110 has been opened along line 110a, and flap 110b of first region 110 has been pulled open.

Model 101 includes a second region 120 that is made of a soft material. In this embodiment, the soft material of second region 120 is also silicone based and non-conductive. In alternative embodiments, second region 120 may be made from latex, acrylic, or another material. Second region 120 represents the parotid gland of a patient undergoing parotid surgery. In alternative embodiments, second region 120 may represent the thyroid gland, cervical lymph nodes, cystic neck masses, or another bodily component. In some embodiments, one or more physical characteristics of second region 120 are set to simulate the physical characteristics of the parotid gland of a patient. The color and/or one or more physical characteristics of the soft material of second region 120 may be different from those of the soft material of first region 110 so that the regions can be easily differentiated by a user of system 100. In this embodiment, the density of the soft material of second region 120 is less than the density of the soft material of first region 110, and the color of the soft material of the second region 120 is yellow.

Model 101 of FIG. 1 is in use. In FIG. 1, second region 120 has been opened along line 120a, and flap 120b of second region 120 has been pulled open. In this embodiment, first region 110 and second region 120 adhere to one another such that flap 110b of first region 110 and flap 120b of second region 120 generally move together. Flap 120a and flap 120b may be held open by a surgical retractor, Lone Star® Hook, or another instrument during the simulated surgery.

Model 101 includes a third region 130. In this embodiment, third region 130 is soft and silicone based. Third region 130 represents a tumor of a patient undergoing parotid surgery. In some embodiments, one or more physical characteristics of third region 130 are set to simulate the physical characteristics of a tumor in a patient. The color and/or other physical characteristics of the material of third region 130 may be different form those of the soft material of second region 120 so that the regions can be easily differentiated. In this embodiment, the density of the material of third region 130 is substantially the same as the density of the soft material of the first region 110. The material of third region 130 is blue. In some embodiments, one or more physical characteristics of the material of third region 130 may be chosen so that third region 130 can be palpated through first region 110 and second region 120. For example, the material of third region 130 may be denser than the soft material of first region 110 and the soft material of second region 120.

Model 101 includes a conductive material 140 that extends through first region 110 and second region 120 to an electrode 155. In this embodiment, the conductive material 140 comprises a partially braided metallic wire. Conductive material 140 is braided at end 140a (which extends through first region 110 to electrode 155) and unbraided at ends 140b, 140c, 140d, 140e, and 140f. Conductive material 140 is made from five strands of 15 cm long 24-gauge bare copper wire. At end 140a, conductive material 140 comprises branded strands of wire. Ends 140b, 140c, 140d, 140e, and 140f comprise the unbraided strands of the branded strands of wire at end 140a. Conductive material 140 represents the facial nerve of a patient. In alternative embodiments, conductive material 140 may represent the recurrent laryngeal nerve, vagus nerve, spinal accessory nerve, jugular vein and/or tributaries, carotid artery and/or tributaries, or another bodily component. As explained below, system 100 is configured so that when a user of system 100 contacts conductive material 140 with an instrument, such as a surgical blade or knife, dissection forceps, pickup forceps, tissue scissors, or other instrument, alarm 152 is activated.

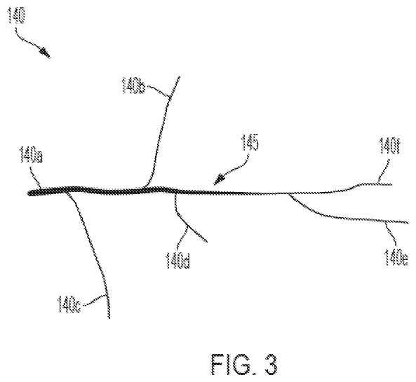

In model 101, conductive material 140 is coated with a non-conductive material 145 (shown in FIG. 3), such as a wax or non-conductive polymer. The use of non-conductive material 145 to coat conductive material 140 allows the user of system 100 to put some pressure on conductive material 140, through non-conductive material 145, without resulting in activation of alarm 152. In this way, system 100 can be used to simulate surgeries where, for example, organic material must be peeled away from the nerve without severing or damaging the nerve. One or more physical characteristics of non-conductive material 145 may be chosen to prevent direct contact between an instrument of the user of system 100 and conductive material 140, and thereby activation of alarm 152, up to a threshold. Conductive material 140 need not be coated with a non-conductive material over its entirety but may be coated only where the user is likely to contact it with an instrument. Model 101 also includes a gauge 190 on the surface of first region 110. In this embodiment, gauge 190 is attached to conductive material 140. Gauge 190 measures tension in or pressure exerted on conductive material 140 and will signal the user of model 101 if tension above a certain threshold is measured on conductive material 140. In alternative embodiments, model 101 need not include a conductive material 140 with non-conductive coating 145 or a gauge 190. Importantly, embodiments where conductive material 140 is not coated with a non-conductive material can also be used to simulate surgeries where, for example, organic material must be peeled away from the nerve without severing or damage the nerve. In these embodiments, the system simply alerts the user that contact has been made with the simulated organic component and that the user should proceed cautiously.

Model 101 of system 100 also includes simulated blood vessels 160 in first region 110 and second region 120. The simulated blood vessels in model 101 are red.

Model 101 includes electrode 155 that is in electrical communication with conductive material 140. In model 101, electrode 155 lies on the surface of first region 110. In alternative embodiments, electrode 155 may lie underneath the first region 110. In model 101, electrode 155 is in electrical communication with first terminal 158 of battery 151 on component 150 via wire 153. Component 150 also includes alarm 152. In this embodiment, alarm 152 includes a light 156 for generating a visual signal and a buzzer 157 for generating an audio signal. Alarm 152 is in electrical connection with second terminal 159 of battery 151 via wire 154. In alternative embodiments, a power source other than a battery may be used.

FIG. 1 also includes tissue scissors 170 for use on model 101. Tissue scissors 170 are in electrical communication with alarm 152 via wire 171 and alligator clip 172. In this embodiment, tissue scissors 170 are also electrically conductive. When tissue scissors 170 contact conductive material 140 the electrical circuit with battery 151 and alarm 152 is completed and light 156 and buzzer 157 are activated. In this embodiment, light 156 and buzzer 157 are deactivated when tissue scissors 170 lose contact with conductive material 140. In alternative embodiments, one or more of battery 151, light 156, and buzzer 157 may be located inside or on top of model 101. In still further embodiments, system 100 may record user contact with conductive material 140 with or without generating an alarm.

FIG. 1 also includes surgical knife 180 for use on model 101. Surgical knife 180 is in electrical communication with alarm 152 via wire 181 and alligator clip 182. In this embodiment, surgical knife 180 is electrically conductive. When surgical knife 180 contacts conductive material 140 the electrical circuit with battery 151 and alarm 152 is completed and light 156 and buzzer 157 are activated. In this embodiment, light 156 and buzzer 157 are deactivated when surgical knife 180 loses contact with conductive material 140. In this embodiment, surgical knife 180 and tissue scissors 170 are both in electrical communication with battery 151 and alarm 152 to facilitate an efficient surgical simulation and to prevent a user of system 100 from having to stop and connect a new instrument to the battery 151 each time the user wishes to use a new instrument on model 101. In alternative embodiments, more than two instruments may be connected to battery 151 and alarm 152 at one time.

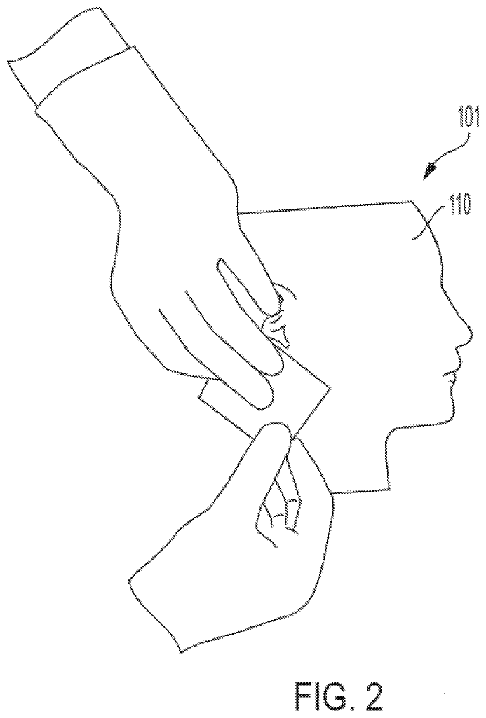

FIG. 2 shows model 101 prior to use for simulation of parotid surgery. First region 110 of model 101 has not been opened, and second region 140 is not visible from this view.

FIG. 3 shows a front view of conductive material 140.

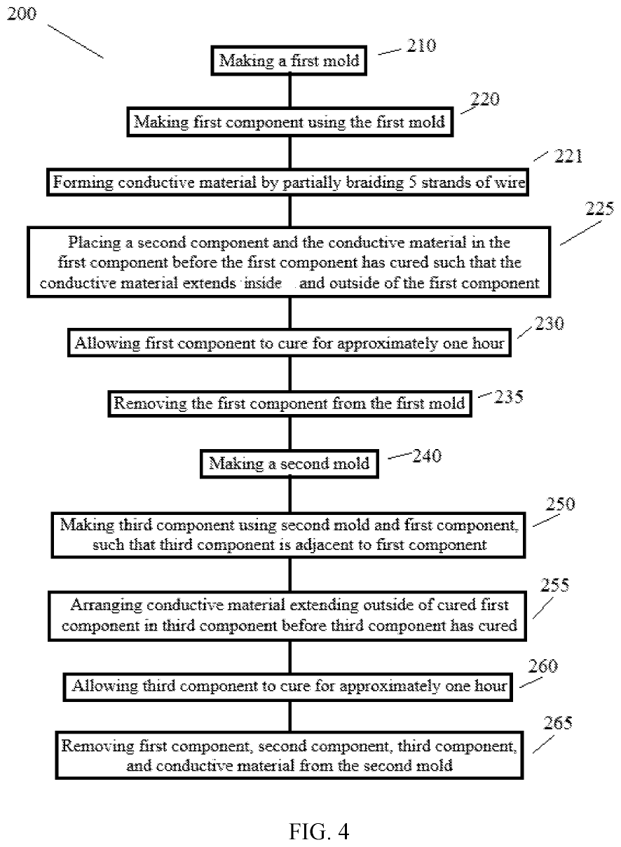

FIG. 4 shows a flow chart 200 for a method for making a model for use in a system. In this embodiment, step 210 includes making a first mold from a mixture of Alja-Safe® Acrobat® powder and water. The first mold is used to make a first component of the model. In alternative embodiments, the first mold is made from a 3-D printer.

At step 220, the first component is made using the first mold of step 210. In this embodiment, the first component is made by mixing approximately 15 ml of Dragon Skin® part A, 15 ml of Dragon Skin® part B, 80 ml of Slacker®, 0.25 ml of yellow pigment, and 0.15 skin tone pigment and pouring the mixture into the first mold. The first component will represent a gland in a patent in the finished model.

At step 221, a conductive material is formed by partially braiding 5 strands of wire. All five strands are braided at one end of the conductive material and all 5 strands remain unbraided at the other ends of the conductive material.

At step 225, before the mixture of the first component of step 220 has cured, a second component and the conductive material are placed within the mixture. The second component may represent a tumor or other object that is to be removed from the first component of the model by a user of the model. The conductive material may represent an object, such as a nerve, that is subject to damage during the surgery to be simulated on the model. In this embodiment, the conductive material extends outside of the first component. In this embodiment, the conductive material is not coated. In alternative embodiments, the conductive material may be coated with a non-conductive material that allows a user simulating surgery with the model to apply pressure, up to a threshold, to the conductive material through the non-conductive material with an instrument without directly conducting the conductive material.

At step 230, the first component is allowed to cure for approximately one hour. At step 235, the first component is removed from the first mold.

At step 240, a second mold is made from a mixture of Alja-Safe® Acrobat® power and water. The second mold is used to make a third component of the model. In alternative embodiments, the second mold is made from a 3-D printer.

At step 250, the third component is made using the second mold of step 240. The third component is made by mixing 250 ml of Dragon Skin® part A, 250 ml of Drag Skin® part B, 80 ml of Slacker®, 3 ml of THI-VEX®, and 3 ml of skin tone flesh pigment and pouring the mixture into the second mold and on top of the cured first component. The third component will represent the skin and flesh of a patient in the finished model.

At step 255, before the mixture of step 250 has cured, the conductive material extending outside of cured first component is arranged in the third component to represent an object, such as a nerve, that is subject to damage during the surgery to be simulated on the model. In this embodiment, one end of the conductive material extends outside of the third component.

At step 260, the third component is allowed to cure for approximately one hour. At step 265, the first component, second component, third component, and conductive material are removed from the second mold.

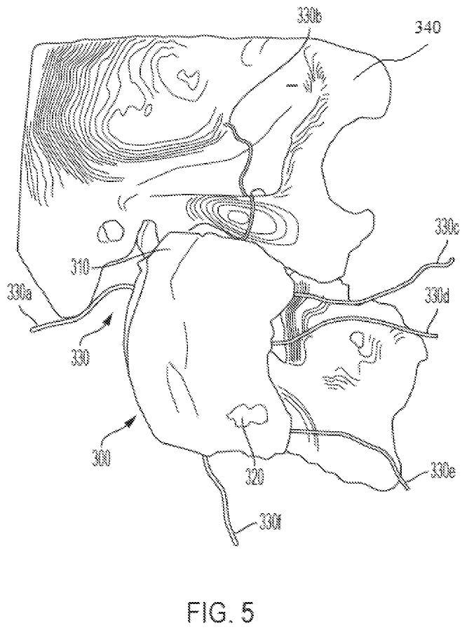

FIG. 5 shows partial model 300. Partial model 300 comprises first component 310, second component 320, and conductive material 330. Also visible is first mold 340 after first component 310 has been removed from the first mold 340 in step 235 of flow chart 200. The conductive material 330 includes braided end 330a, which comprises five braided strands of wire, and unbraided ends 330b, 330c, 330d, 330e, and 330f, which each comprise one strand of the strands of braided end 330a.

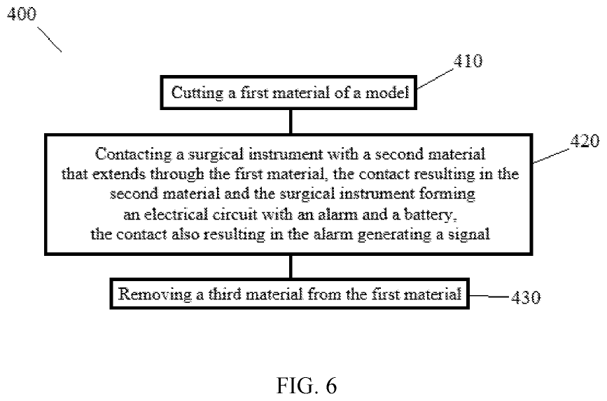

FIG. 6 shows a flowchart 400 for simulating a surgery with a system. In this embodiment, step 410 comprises cutting a first material of a model, the first material being soft and silicone-based.

Step 420 comprises contacting a surgical instrument with a second material that extends through the first material, the contact resulting in the second material and the surgical instrument forming an electrical circuit with an alarm and a battery, the contact also resulting in the alarm generating a signal.

Step 430 comprises removing a third material from the first material.

1. A system for simulating a surgical procedure with an instrument comprising:
a first material for manipulation with the instrument, the first material being soft;
a second material extending through the first material, wherein the second material is electrically conductive; and
a device for generating a signal, the device for generating a signal in electrical communication with the second material.

2. The system of claim 1, wherein the signal generated by the device for generating a signal is an audio or visual signal.

3. The system of claim 1, wherein the device for generating a signal is configured to generate a signal when the second material is contacted by the instrument.

4. The system of claim 3, wherein the second material is in electrical communication with a battery.

5. The system of claim 4, wherein the battery is in electrical communication with the instrument.

6. The system of claim 3, further comprising:
a third material within the first material, the third material representing a tumor to be removed during the surgical procedure.

7. The system of claim 6, further comprising:
a fourth material, the fourth material and the first material representing different tissue or tissues of a patient, the second material extending through the first material and the fourth material.

8. The system of claim 7 wherein the fourth material represents a gland.

9. The system of claim 7, wherein the first material and the fourth material are silicone-based, and the second material comprises a wire.

10. The system of claim 9, wherein the second material comprises braided strands of metal wires at one end and an unbraided strand of metal wire at another end.

11. The system of claim 10, further comprising:
a pressure gauge for determining the amount of pressure exerted on the second material by the instrument.

12. A system for simulating a surgical procedure with an instrument comprising:
a first material, the first material being soft and for manipulation by the instrument;
a second material, the second material being electrically conductive and extending through the first material;
an indicator for generating a signal;
a battery; and
the second material, the indicator, and the battery being components of an electrical circuit that activates the indicator when the instrument contacts the second material.

13. The system of claim 12 wherein the first material is silicone based and the second material comprises a wire.

14. The system of claim 13 further comprising:
a third material for removal during simulation of the surgical procedure, the third material being in the first material.

15. A method of simulating a surgical procedure, the method comprising:
manipulating a first material;
contacting a surgical instrument with a second material, the second material extending within the first material, the surgical instrument and the second material being components of an electrical circuit.

16. The method of claim 15 wherein the electrical circuit includes an indicator for indicating when the surgical instrument contacts the second material.

17. The method of claim 16 wherein the electrical circuit includes a battery for powering the electrical circuit.

18. The method of claim 17 wherein the first material is soft and silicone based and the second material comprises a wire.

19. The method of claim 18 further comprising:
removing a third material from the first material.
